(19) United States
(12) Patent Application Publication
(10) Pub. No.: US 2017/0254462 A1
(43) Pub. Date: Sep. 7, 2017

(54) Improved Valve Apparatus And Method Of Installation

(71) Applicants: Paul Ffoulkes, Cowlyn Bay, Conwy (GB); Kevin Dobbs, Scunthorpe, North Lincolnshire (GB)

(72) Inventors: Kevin Dobbs, Scunthorpe, North Lincolnshire (GB); William Taylor-Veitch, Sunderland, Tyne and Wear (GB)

(21) Appl. No.: 15/508,786

(22) PCT Filed: Sep. 4, 2015
(86) PCT No.: PCT/GB2015/052555

§ 371 Date: Mar. 3, 2017

(30) Foreign Application Priority Data
Sep. 5, 2014 (GB) 1415770.5

(51) Int. Cl. F16L 41/06; F16K 5/04; F16L 55/18; F16K 43/00

(52) U.S. Cl. CPC F16L 41/06; F16K 43/001; F16K 5/0492; F16L 55/18; F16L 41/04

(57) ABSTRACT

This invention relates to an apparatus for adapting an existing pipeline. The apparatus includes a clamp portion adapted to fit around at least part of an existing pipeline in use and at least one neck or branch portion depending from the clamp portion, and a valve means.

The invention to which this application relates is an improved apparatus for use in installing a valve into existing pipework.

Although the following description refers exclusively to the fitting of valves into water pipework and water mains, the person skilled in the art will appreciate that the present invention can be used on any pipework carrying any fluid and is not limited to pipework for carrying water.

Conventionally, modifications to pipework such as water mains and the like require a line stop and/or ‘hot tap’ process whereby a neck or branch pipe fitting (also known as a T or Tee junction) is fitted to the existing pipework through which the drilling machinery to create an opening into the existing pipe is introduced as well as any stopping plugs, valves and/or other such equipment. GB2465310 describes the insertion of a valve into an existing pipeline.

One problem with conventional techniques and fittings is that multiple pieces of equipment have to be joined to the Tee junction to complete the operations before the Tee is capped or further pipework added to the same. The addition and removal of equipment is costly, time consuming and represents a risk to the safety of the operatives working around the pipeline excavation. Furthermore, the point of connection for the equipment to the Tee represents a potential leakage point during operations and when the works have been completed.

It is therefore an aim of the present invention to provide an apparatus that addresses the abovementioned problems.

It is a further aim of the present invention to provide a method of using and/or fitting an apparatus that addresses the abovementioned problems.

It is a yet further aim of the present invention to provide a method of manufacturing an apparatus that addresses the abovementioned problems.

In a first aspect of the invention there is provided an apparatus for adapting an existing pipeline said apparatus including a clamp portion adapted to fit around at least part of an existing pipeline in use, at least one neck or branch portion depending from said clamp portion and wherein the apparatus includes a valve means.

Thus an apparatus is provided to clamp around an existing pipe to provide at least one neck or branch from the same, wherein said apparatus also includes a valve means to control, regulate and/or stop flow through said apparatus and/or neck.

Typically the at least one neck or branch portion forms a Tee or T junction conduit depending from the clamp portion. Further typically the valve means controls the flow of fluid through said neck or branch portion.

In one embodiment the apparatus includes a housing. Typically at least the neck or branch portion and the valve means are defined by and/or located within the housing. Further typically the housing defines a unitary body which includes the clamp portion, neck or branch portion and said valve means.

Preferably the valve means is integrally formed with the neck or branch portion.

In one embodiment the neck or branch portion protrudes from the clamp thereby forming a Tee-assembly. In an alternative embodiment the neck or branch does not substantially protrude from the housing thereby forming a substantially cylindrical apparatus. In such an embodiment the Tee assembly would be located in a substantially cylindrical housing.

In one embodiment the valve can be opened to such an extent that other equipment and/or materials including any one or any combination of drilling equipment, boring equipment, plugs, valves and/or the like can pass through the valve means. Typically the drilling or boring equipment is passed through the valve to drill or bore into the existing pipework to which the apparatus is attached. Further typically the apparatus provides a full bore inline construction valve. Thus drilling under pressure can take place in a fraction of the time of conventional systems.

In one embodiment the neck or branch portion includes adaptor means. Typically the adaptor means is configured to be a pipe coupling and/or flange adaptor. Further typically the valve means is located between the clamp portion and the adaptor means.

In one embodiment the adaptor means is configured such that a cap or sealing plate and/or further pipework can be attached to the same.

Typically at least the neck or branch portion is circular or round when viewed in horizontal cross section. Preferably the bore of the neck or branch portion is circular/round.

In one embodiment at least part of the apparatus is constructed from ductile iron. Typically the housing is substantially constructed from ductile iron.

In one embodiment the valve means is a gate valve. The person skilled in the art will appreciate that other types of valve could be used such as knife valve, butterfly valve, plug valve and/or the like.

In one embodiment the clamp member includes at least two parts. Typically the clamp member is adapted to conform or abut to the outer surface of an existing pipe in use. Further typically the clamp member and/or parts thereof are secured around the pipe using fastening means such as bolts, nuts and/or the like.

In one embodiment the clamp member includes two opposed parts that can be secured around a pipe. Typically fastening means are used to secure the clamp parts.

In one embodiment the clamp member and/or parts thereof include flanges or skirts through which the fastening means can be secured.

In one embodiment the clamp member is a saddle clamp.

In one embodiment the clamp member includes one or more plates or mats. Typically the plates or mats aid sealing of the clamp member to the pipeline. Further typically the plates or mats are waffle seals.

In a second aspect of the invention there is provided a method of installing an apparatus and/or adapting a pipeline using an apparatus, said apparatus including a clamp portion adapted to fit around at least part of an existing pipeline in use, at least one neck or branch portion depending from said clamp portion and wherein the apparatus includes a valve means wherein the method includes the step of attaching said clamp means to a pipe or pipework.

Typically the clamp portion is opened and/or substantially disassembled before fitting around the pipeline.

In one embodiment the waffle seals are lubricated.

Specific embodiments of the invention are now described with reference to the following figures wherein:

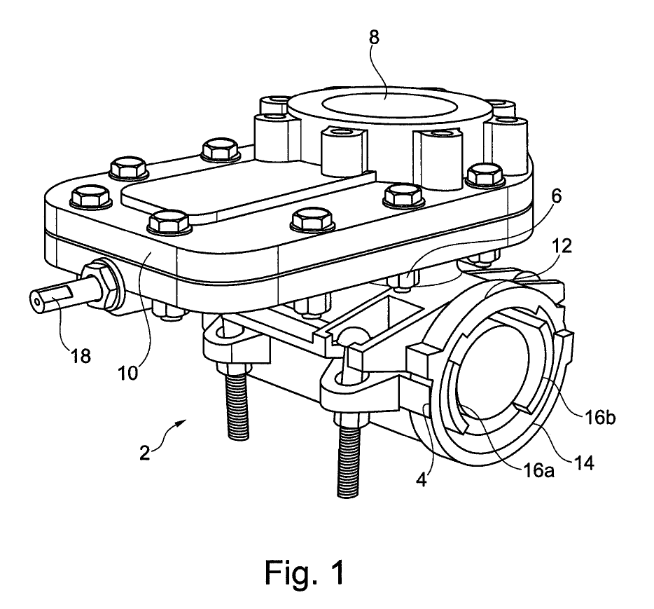

FIG. 1 shows a perspective view of an apparatus in accordance with one aspect of the invention;

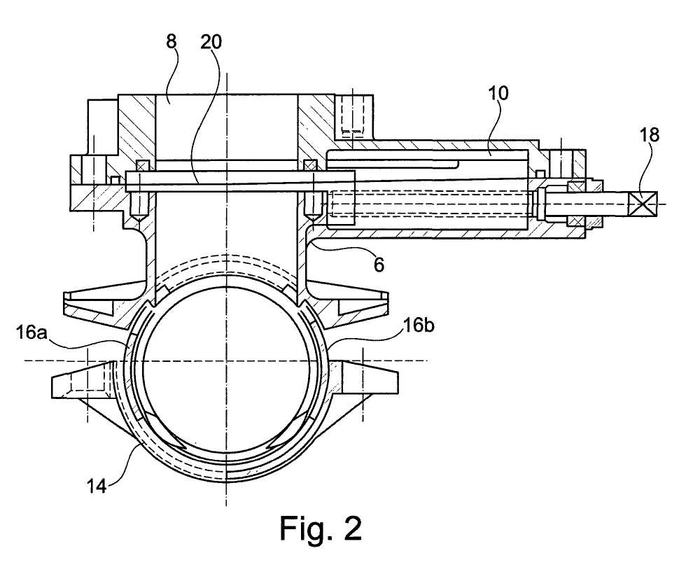

FIG. 2 shows a front cross sectional view of an apparatus in accordance with one aspect of the invention; and

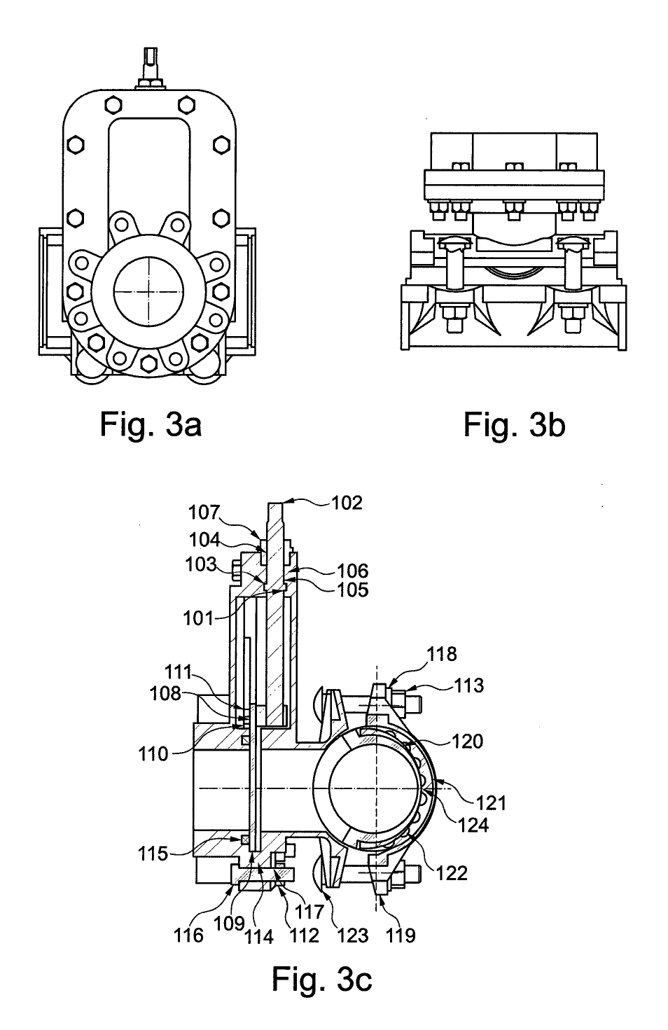

FIGS. 3a-c show plan, side and cross-sectional views respectively in accordance with a further embodiment of the invention.

The present invention relates to a combined tee-valve that has been developed to provide a full bore inline construction valve that allows under-pressure drilling and line stopping to take place in a fraction of the time with the added cost advantage and the minimal time required. This is a huge Health and Safety advantage for the end user and contractor.

Turning to FIG. 1 a combined tee valve 2 is shown which comprises a clamp 4 which is shaped to fit around an existing pipe in use, sandwiching the same between the parts of the clamp. A tee 6 defining a conduit 8 that depends away from the clamp 4 and the pipe located within the same (not shown) in a perpendicular direction is equipped with an integral gate valve 10. The gate can be fully retracted to allow full bore access via the conduit to the pipe held in the clamp. This allows equipment, such as cutting tool, flow plugs, second valves and the like to pass through the tee conduit 8 into the existing pipework.

The person skilled in the art will appreciate that the tee can be any reasonable length sufficient to incorporate a valve.

The clamp 4 in this example is a saddle-type clamp with an upper clamp section 12 and a lower clamp section 14 which fit around a pipe and the apparatus 2 is fixed around the same by fastening the nuts and bolts together to draw the opposing upper and lower sections together.

The clamp also includes plates 16a, 16b that are pressed around the pipe as the bolts are tightened, thereby improving the clamp seal. In this example the clamps include a polymeric material and are usually called waffle mats.

The valve 10 is actuated by turning the valve member 18 to open and close the valve.

Typically there are several checks performed before the tee is installed including;
Checking the outside diameter of host main or pipeline, ensuring that any ovality is within the tolerance of the clamp;
Checking overall condition of pipework;
Pressure rating;
Flow rating.

Prior to drilling into the pipe the assembly process of lower clamp assembly prior to drilling operation includes:
(1) Dis-assembly of lower clamp section by loosening retaining nuts ensuring that bolts are held captive;
(2) Ensure waffle seals are lubricated;
(3) Place top half of combined valve onto host pipe and rotate into position;
(4) Attach bottom half of clamp underneath valve section and locate fasteners into position;
(5) Ensure waffle mat section is inserted correctly;
(6) Proceed to tighten bolts in a diametrical position until evenly tightened;
(7) Ensure bolts are torqued to 95-120 Nm;
(8) Proceed to Pipe drilling process and proceed against issued Site Services RAMS.

FIG. 2 shows a cross section through the valve-tee apparatus 2. The valve gate 20 moves linearly in a horizontal plane and is actuated by rotating the key 18. When fully open the conduit 8 allows full bore access to the pipe clamped between the jaws 16. Thus other equipment, such as drills and the like can pass through the same.

FIGS. 3a-c show plan, side and cross-sectional views respectively for a further embodiment of the combined tee valve invention. The combined tee valve includes a body or housing 101, through which a spindle 102 passes. A washer 103, gland 104, o-ring 105, 106 and nut 107 arrangement surrounds the spindle 101 as it passes through the body 102. A spindle nut 108 engages the spindle with the gate 109 such that rotation of the spindle moves the gate in a linear direction.

A number of nuts 110-113, and bolts 116, 123 secure the cover 114 and gate seal 115 therebetween, together. In addition, bolts secure together the parts of the pipe clamp 119 and the optional inserts 120, 122 and gaskets 121, 124 together around the pipe (not shown).

As such, the skilled person will appreciate that the present invention allows the efficient and safe addition of a tee including a valve means to an existing pipeline. The nominal bore diameter substantially matches the internal diameter bore of the combined valve tee conduit.

1. An apparatus for adapting an existing pipeline, said apparatus comprising:
a clamp portion adapted to fit around at least part of an existing pipeline in use;
at least one neck or branch portion depending from said clamp portion; and
a valve means for control fluid flow.

2. Apparatus according to claim 1 wherein the at least one neck or branch portion forms a Tee or T junction conduit depending from the clamp portion

3. Apparatus according to claim 1 wherein the valve means controls the flow of fluid through said at least one neck or branch portion.

4. Apparatus according to claim 1 including a housing having the at least one neck or branch portion and the valve means located within.

5. Apparatus according to claim 4 wherein the housing defines a unitary body which includes the clamp portion and the valve means located within the housing.

6. Apparatus according to claim 5 wherein the valve means is integrally formed with the at least one neck or branch portion.

7. Apparatus according to claim 6 wherein the at least one neck or branch portion does not substantially protrude from the housing thereby forming a substantially cylindrical apparatus having a Tee assembly located in a substantially cylindrical housing.

8. Apparatus according to claim 1 wherein the valve means can be opened to such an extent that other equipment and/or materials can pass through the valve means.

9. Apparatus according to claim 8 wherein the valve means is of sufficient dimensions for drilling or boring equipment to pass through the valve to drill or bore into the existing pipework to which the apparatus is attached.

10. Apparatus according to claim 1 wherein the at least one neck or brank portion includes adaptor means selected from the group consisting of a pipe coupling and flange adaptor.

11. Apparatus according to claim 10 wherein the valve means is located between the clamp portion and the adaptor means.

12. Apparatus according to claim 11 wherein the adaptor means is configured for a cap or sealing plate and/or further pipework to be attached to the adaptor means.

13. Apparatus according to claim 1 wherein at least part of the apparatus is constructed from ductile iron.

14. Apparatus according to claim 4 wherein the housing is substantially constructed from ductile iron.

15. Apparatus according to claim 1 wherein the valve means is a gate valve.

16. Apparatus according to claim 1 wherein the clamp portion includes at least two parts, at least part of which is adapted to conform or abut to an outer surface of an existing pipe in use.

17. Apparatus according to claim 16 wherein the clamp portion and/or parts thereof are secured around the pipe using fastening means.

18. Apparatus according to claim 17 wherein the clamp portion and/or parts thereof include flanges or skirts through which the fastening means can be secured.

19. Apparatus according to claim 16 wherein the clamp portion is a saddle clamp.

20. Apparatus according to claim 16 wherein the clamp portion includes one or more plates or mats to aid sealing of the clamp portion to the pipeline.

21. Apparatus according to claim 20 wherein the plates or mats are waffle seals.

22. A method of installing an apparatus and/or adapting a pipeline using an apparatus including a clamp portion adapted to fit around at least part of an existing pipeline in use, at least one neck or branch portion depending from said clamp portion and wherein the apparatus includes a valve means, the method includes the step of attaching said clamp means to a pipe or pipework.

23. A method according to claim 22 wherein the clamp portion is opened and/or substantially disassembled before fitting around the pipeline.

24. A method according to claim 22 wherein drilling or boring equipment is attached to one side of the valve means and said valve means opened such that at least part of the drilling or boring equipment passes through a valve ball or bore into the existing pipework to which the apparatus is attached.
